(19) United States
(12) Patent Application Publication
(10) Pub. No.: US 2018/0079979 A1
(43) Pub. Date: Mar. 22, 2018

(54) ADVANCED THERMAL TREATMENT APPARATUS

(71) Applicant: STANDARD GAS LIMITED, London (GB)

(72) Inventor: Daniel Michael Donegan, Essex (GB)

(21) Appl. No.: 15/554,197

(22) PCT Filed: Mar. 4, 2016
(86) PCT No.: PCT/GB2016/050582

§ 371 Date: Aug. 28, 2017

(30) Foreign Application Priority Data
Mar. 5, 2015 (GB) 1503770.8

(51) Int. Cl. C10J 3/72; C01B 3/02; C10B 1/10

(52) U.S. Cl. CPC C10J 3/721; C01B 3/02; C10J 2300/0979; C10J 2200/156; C10J 2300/0976; C10B 1/10

(57) ABSTRACT

A system for pyrolysis or gasification having a first pyrolysis or gasification unit 50 connected to a second pyrolysis or gasification unit 53 by a hermetically sealed gas path. Pyrolysis is used to destroy calorific waste and/or to produce gas therefrom.

### FIELD OF DISCLOSURE

The present invention generally relates to Advanced Thermal Treatment methods and apparatuses. Advanced Thermal Treatment (e.g. pyrolysis or gasification) is used to destroy calorific waste and/or to produce gas therefrom. The destruction of calorific waste is desirable to avoid the need for environmental damage due to burial in landfill sites, or dumping at sea. However, some forms of destruction create gaseous pollution and/or carbon dioxide, leading to environmental damage and potentially increasing global warming.

### BACKGROUND

Advanced Thermal Treatment (ATT) primarily relates to technologies that employ pyrolysis or gasification. ATT is discussed in the Brief, entitled ‘Advanced thermal treatment of municipal solid waste’ produced by the Department for Environment, Food & Rural Affairs of the UK Government (https://www.gov.uk/government/publications/advanced-thermal-treatment-of-municipal-solid-waste). That Brief indicates a problem with conventional pyrolysis and gasification systems is tarring, in which the build up of tar can cause operational problems (for example, if tar build up causes blockages).

Pure pyrolysis is a process of thermochemical decomposition of material to produce gas, in which oxygen is absent. If a small quantity of oxygen is present, the production of gas is termed gasification. The amount of oxygen present in gasification is insufficient to allow combustion to occur. In the present application, unless otherwise specified, pyrolysis and gasification will have the same meaning.

In an ATT process, gas is released from a feed material or ‘feedstock’, leaving solid matter (char) as a by-product. The skilled person will understand that the term ‘feedstock’ as used throughout this description relates to any solid material having a calorific value. Feedstocks typically envisaged in this context are waste materials such as biomass, wood or paper, rubber tyres, plastics and polythene, or sewage solids. They also include low quality fossil fuels such as lignite or bituminous coals. The feedstock of ATT units for generating syngas may be most carbon-based materials with a calorific value. For example, fossil fuels can be used. However, in conventional ATT units, the feedstock must be prepared before entering the unit, thus adding additional time and expense to the process.

Conventionally, part of the preparation process includes drying the feedstock, as water may cool the ATT unit, thereby reducing the efficiency of the ATT process and increasing the amount of tars, oils and PAHs in the resulting gas. Moreover, in preparing the feedstock, certain material with a calorific value may be rejected as being non-compliant with a given ATT unit. For example, certain feedstock materials may be difficult for some fuel specific ATT technologies to breakdown using thermal processes.

The released gas, termed synthetic gas or “syngas” hereafter, can then be used as a fuel to generate heat or electricity either on the spot or elsewhere. If carbonaceous material is used as the feedstock, the resulting solid residue (“char”) is generally richer in carbon. That char also may be used as a secondary fuel source. Generally, conventional pyrolysis processes do not result in syngas pure enough to be input into a generator. Instead, the syngas must first be put through a rigorous cleaning (scrubbed) process, so that any remaining particulate matter and tar are removed from the syngas. The retention of tar and oil is the consequence of insufficient temperature and dwell time.

Those oils and tars can contain polycyclic aromatic hydrocarbons, PAHs, (also termed poly-aromatic hydrocarbons), which are organic pollutants that may be formed from incomplete combustion of carbonaceous material (such as wood, coal, oil etc). PAHs can be hazardous to human health, and can have toxic and/or carcinogenic properties. It is therefore preferable that gas exiting the pyrolysis system is free from oils and tars, and therefore from PAHs.

PAHs usually have high melting points and boiling points. The boiling points may, for example, be 500° C. or more. For example, Picene (C₂₂H₁₄) has a boiling point of around 520° C. and a melting point of around 365° C. and Coronene (C₂₄H₁₂) has a boiling point of around 525° C. and a melting point of around 440° C. Accordingly, thermochemical decomposition, or ‘cracking’, PAHs requires very high temperatures and the PAHs are difficult to remove using a conventional pyrolysis process.

In some variants, a pyrolysis system includes a rotary retort in which the pyrolysis process takes place. The rotation of the retort helps to mechanically break up the feedstock. In order to provide adequate structural strength conventional rotary retorts may be made of materials such as steel or nickel alloy. Such materials are not particularly efficient thermal conductors, meaning that a large portion of the energy used to heat the rotary retort is not transferred to the feedstock and/or gas within the retort. It is difficult, therefore, to raise the temperature of inside of the retort to a level sufficient to fully crack the PAHs. The syngas exiting a conventional retort therefore contains particulate tars and oils, including the PAHs. Whilst the dwell time within the retort can be increased to crack the PAHs, this reduces the throughput of feedstock and therefore reduces the efficiency of the pyrolysis system.

WO2005/116524 describes plant equipment which includes two gasifiers. Char from the primary gasifier is used as fuel in the secondary gasifier. The primary gasifier is a rotary kiln consisting of a rotating, slightly inclined metal shell or tube which transports fuel along its length. The exhaust gas from the secondary gasifier external to the kiln heats the tube.

WO2005/116524 further describes an apparatus and process for converting carbonaceous or other material with calorific value into high quality gas preferably to fuel a reciprocating gas engine for the generation of electricity. Wet fuel enters the unit, whereupon it is dried. The dried fuel then is checked for size via a trammel. Correctly sized fuel passes through the trammel and oversized fuel goes onto the reject conveyer where it is delivered for shredding, after which the fuel may be the correctly sized. The correct sized dry fuel is then compacted, forming a cylindrical fuel plug and fed via a feed system, to avoid the ingress of air, into a gasifier provided with an internal vane configuration, which allows homogenous distribution of the feed material over a large area of a retort. This exposes the feed material to heat without the need for rapid tumbling and agitation. The gas released by the arrangement WO2005/116524 is cooled and cleaned in a gas quench unit.

One issue with many conventional ATT systems is the inability to completely crack some materials. The syngas exiting those ATT systems therefore contains particulates, such as tars and oils, that must be removed from the syngas before the syngas can be used.

To account for those particulates, a process involving super critical water process can be used. A fluid may be described as ‘super critical’ when its temperature and pressure exceed its critical point. For water, the critical point is at 374° C. and 221 bar (22.1 MPa). Above that pressure and temperature, water enters a super critical state in which the miscibility of organic substances is increased. This effect can be used to destroy pollutants, such as polycyclic hydrocarbons. It is thought that the increased miscibility of organic substances in supercritical water is due to the reduced effect of hydrogen bonding (“Supercritical Water-A Medium for Chemistry”—Shaw, R. W.; Thomas, B. B.; Antony, A. C.; Charles, A. E.; Franck, E. U.—Chem.Eng.News 1991 Dec. 23, 26.).

U.S. Pat. No. 4,113,446 relates to the conversion of solid or liquid organic materials into high energy gas using supercritical water. The use of a hydrogenation catalyst during such conversion can result in increased conversion of the organic materials into high energy gas.

U.S. Pat. No. 5,780,518 relates to the use of superheated steam for the pyrolysis of the waste material. Superheated steam, amounting to between 18 and 110 percent of the mass of the rubber waste, is used as the heat carrier. High temperature water vapour goes from a steam generator to a reactor to pyrolyse rubber tires.

US2009/0206007 discusses a process by which coal is converted into hydrocarbons using a supercritical water process, involving two stages: a first stage in which carbonaceous material is reacted with supercritical water at above 850K to produce a first supercritical fluid reaction mixture comprising hydrocarbon compounds; and a second stage in which hydrocarbon compounds are extracted from coal mixed with at least a portion of the first supercritical fluid at a temperature within a range of from the supercritical temperature of water to about 695K. Char from the second stage is finely divided and may be used outside the process.

In conventional arrangements, however, energy must be expended in order to create the supercritical water or super heated steam, thereby leading to an inefficiency in the system.

### Means for Solving the Problem

The inventors have devised novel and inventive Advanced Thermal Treatment (pyrolysis and gasification) apparatuses and techniques. A broad description will be given of specific aspects of the invention. Preferred features of the specific aspects are set out in the dependent claims.

According to the present invention there is provided a system for pyrolysis or gasification having a first pyrolysis or gasification unit connected to a second pyrolysis or gasification unit by a hermetically sealed gas path. Advantageously, heated gaseous mixture from the first pyrolysis or gasification unit can enter the second pyrolysis or gasification due to the hermetically sealed gas path, thus inputting a heat source into the interior of the second pyrolysis or gasification unit. According to the present invention, there is provided a method for pyrolysis or gasification, characterised in that gas resulting from a first pyrolysis or gasification process in a first pyrolysis or gasification process unit undergoes a second pyrolysis or gasification process in a second pyrolysis or gasification process unit.

A pyrolysis or gasification (ATT) process occurring in the second pyrolysis or gasification is therefore requires less heat from external heat sources. Additionally, the heat of the gaseous mixture exiting the first pyrolysis or gasification unit is used in the second pyrolysis or gasification unit rather than the gaseous mixture undergoing a heat recovery operation. Accordingly, the pyrolysis or gasification system of the present invention is more efficient than conventional systems.

In some aspects, the second pyrolysis or gasification unit is a rotable retort. The hermetically sealed gas path connects to the second pyrolysis or gasification unit through a bearing of the retort. The heated gaseous mixture from the first pyrolysis or gasification unit is therefore input near the axis of the second pyrolysis or gasification unit. Conventionally, when a pyrolysis or gasification retort is only heated externally, a cool region is located near the axis due to the drop off in radiative and convective heat transfer from the surface of the retort as the axis is approached. By inputting the heated gaseous mixture at or near the axis of the second pyrolysis or gasification retort, such cool regions can be avoided.

In some aspects, the first pyrolysis or gasification unit is a rotable retort.

In some aspects, the hermetically sealed gas path is connected to a perforated gas input pipe inside the second pyrolysis or gasification unit. Gas is directed along a hermetically sealed path from the first pyrolysis or gasification unit to the second pyrolysis or gasification unit. This helps to disperse the gaseous mixture from the first pyrolysis or gasification unit over a larger portion of the second pyrolysis or gasification unit.

Some aspects comprise a first thermally insulated housing enclosing the first pyrolysis or gasification unit and a second thermally insulated housing enclosing the second pyrolysis or gasification unit. Preferably, an exhaust duct connects the first thermally insulated housing to the second thermally insulated housing, the exhaust duct being adapted to direct exhaust from the interior of the first thermally insulated housing to the interior of the second thermally insulated housing. Exhaust from a first heating system associated with the first pyrolysis or gasification process unit heats the second pyrolysis or gasification process unit.

Hot air used to heat the first pyrolysis or gasification unit is therefore also used to heat the second pyrolysis or gasification unit rather than venting to atmosphere or being sent through a heat recovery system. This improves the efficiency of the pyrolysis or gasification system as a whole as the second pyrolysis or gasification unit requires less additional heat to provide a pyrolysis or gasification process.

Some aspects comprise a first heating system adapted to heat the interior of the first thermally insulated housing and a second heating system adapted to heat the interior of the second thermally insulated housing. A second heating system associated with the second pyrolysis or gasification process unit heats the second pyrolysis or gasification process unit.

In some aspects, the coefficient of thermal conductivity of the second pyrolysis or gasification unit is higher than the coefficient of thermal conductivity of the first pyrolysis or gasification unit. As many hydrocarbons will have been cracked in the first pyrolysis or gasification unit (i.e. many oils, tars and PAHs will have been pyrolysed or gasified), more heat will be required to crack the remaining hydrocarbons. A higher than the coefficient of thermal conductivity allows more heat to be transferred from the outside of the second pyrolysis or gasification unit to the inside, thereby improving the chances of cracking the remaining hydrocarbons.

Some aspects comprise a thermally insulated housing enclosing the first pyrolysis or gasification unit, the second pyrolysis or gasification unit and the hermetically sealed gas path. Both pyrolysis or gasification units can therefore benefit from all external heat sources.

In some aspects, the gas resulting from the first pyrolysis or gasification process includes a moisture content. Preferably, the pressure and temperature in the second pyrolysis unit are sufficient that the moisture content becomes superheated steam. Preferably, the pressure and temperature in the second pyrolysis unit are sufficient that the moisture content is in a supercritical state. Superheated steam and water in a supercritical state are both advantageous for cracking hydrocarbons. Conventionally, a separate steam generator is required, which is inefficient in terms of energy used to heat the water. Using a first pyrolysis or gasification process to create superheated steam or supercritical water removes the need for that additional steam generator. As a result, heat used to create the superheated steam or supercritical water is also used in the second pyrolysis or gasification process. In some aspects, wet feedstock having a moisture content of 20%-30% by weight is input into the first pyrolysis or gasification process unit.

### BRIEF DESCRIPTION OF THE DRAWINGS

Various embodiments and aspects of the present invention are described without limitation below, with reference to the accompanying figures.

FIG. 1 is a schematic side view of the pyrolysis or gasification system according to a first preferred embodiment

FIG. 2 is a sectional end elevation of a first pyrolysis or gasification apparatus according to the first preferred embodiment.

FIG. 3 is a section side elevation of a part of the first preferred embodiment.

FIG. 4 is a section side elevation of a part of the first preferred embodiment.

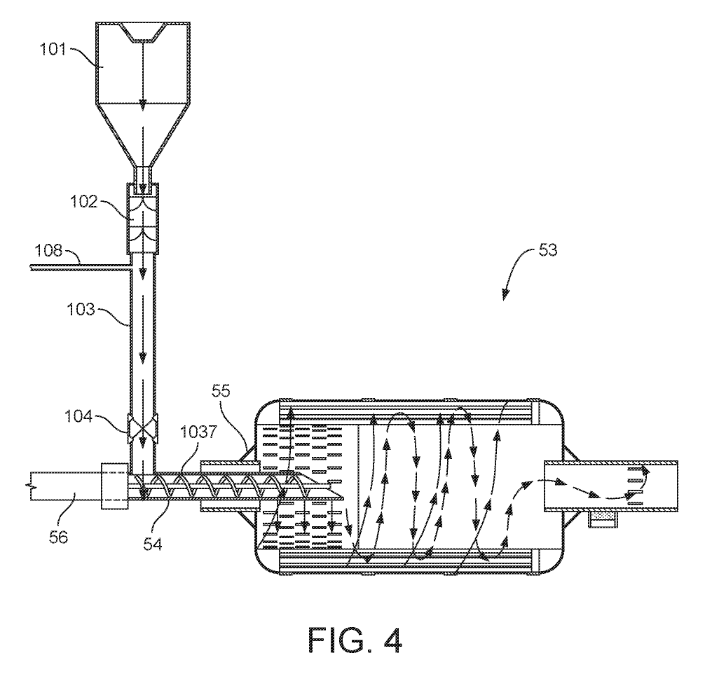

FIG. 5 is a schematic plan view of the pyrolysis or gasification system according to the first preferred embodiment.

FIG. 6 is a schematic side view of the pyrolysis or gasification system according to a second preferred embodiment.

FIG. 7 is a schematic plan view of the pyrolysis or gasification system according to the second preferred embodiment.

FIG. 8 is a representative end view of three pyrolysis or gasification retorts in accordance with an aspect of the second preferred embodiment.

### DETAILED DESCRIPTION OF A PREFERRED EMBODIMENT

The following description relates to Advanced Thermal Treatment (ATT) of feedstock. Specific examples of ATT include pyrolysis and gasification. In the present description, ‘ATT’ will be used to encompass both pyrolysis and gasification. It will be understood that the description of an ATT apparatus may equally relate to a gasification apparatus or a pyrolysis apparatus. Similarly, the description of an ATT method or process may equally relate to a gasification method or process, or a pyrolysis method or process.

### First Preferred Embodiment

The present invention generally relates to the use of a first ATT unit 50 connected to a second ATT unit 53 by a hermetically sealed gas path.

An enclosed gas path leads from the first ATT unit 50 into the second ATT unit 53. A gaseous mixture created in the first ATT unit 50 is fed into the second ATT unit 53 through a hermetically sealed gas path. The gaseous mixture includes syngas, particulates such as oils and tars, and, if the feedstock has a moisture content, water. In the preferred embodiment, a first ATT process occurs in the first ATT unit 50. The resulting gaseous mixture is then directed, through the hermetically sealed gas path, into the second ATT unit 53, in which a second ATT process occurs. When more than two ATT units are provided, a hermetically sealed path is provided from the exit of the first ATT unit 50 to the exit of the second ATT unit 53.

If the initial feedstock had moisture content, and therefore the gaseous mixture contains water, that second ATT process is carried out in the presence of super heated steam or super critical water. Accordingly, remaining organic substances are more readily dissolved than in the first ATT process, or in a conventional ATT system, and residual tars and PAHs can be more readily broken down. As a result, the syngas exiting the second ATT unit 53 is cleaner than conventional ATT systems. Advantageously, the present invention does not require a separate, dedicated, steam generator. Instead, feedstock, having a moisture content, undergoes a first ATT process in a first ATT unit. The resulting gaseous mixture is then directed toward a second ATT unit wherein a second ATT process occurs in the presence of superheated steam, or supercritical water depending on the temperature and pressure of the water within the gaseous mixture from the first ATT unit.

Feedstock for the present invention may include any material with a calorific value. Advantageously, there is no requirement to pre-treat the feedstock other than to ensure it physically fits into the ATT system. Accordingly, feedstock having a moisture content may be used with the present ATT system. For example, feedstock having a moisture content of 20%-30% by weight can be processed by the ATT system without the need to first dry the feedstock, as would be the case in a conventional ATT system. In some arrangements, a moisture content of as little as 10% by weight is used. It is to be noted that the arrangement described herein is able to process treated (e.g. dried) feedstock in addition to untreated (e.g. wet) feedstock.

As the first ATT unit 50, the hermetically sealed path and the second ATT unit 53 form an enclosed volume, water in the gaseous mixture resulting from the first ATT process can reach superheated temperatures (i.e. the water may be above 100° C.). Further, the increase in the temperature of the water within an enclosed volume additionally results in an increase in pressure. As the temperature in the ATT system is sufficient for pyrolysis/gasification, the temperature of the water in the gaseous mixture, in some embodiments, can exceed 374° C. (i.e. the critical temperature of water). Additionally, the increase in pressure can cause the pressure of the water within the gaseous mixture to exceed 22.1 MPa (i.e. the critical pressure of water). In that event, the water reaches a supercritical state. This diameter and length of the piping leading from the first ATT unit 50 to the second ATT unit 53 can be chosen to cause the water within the gaseous mixture to enter a super critical state. For example, the smaller the diameter, the greater the increase in pressure within the piping.

In some aspects, a compressor is provided downstream of the first ATT unit 50, and upstream of the second ATT unit 53, to ensure that water entering the second ATT unit 53 from the first ATT unit 50 is pressurised sufficiently to be in a supercritical state.

The gaseous mixture is directed, via the hermitically sealed path into the second ATT unit 53. In the second ATT unit 53, a second ATT process occurs.

### First ATT Apparatus

The first ATT apparatus comprises a first ATT unit 50, a first thermally insulated housing 40 and a first heating system 52. In general, any pyrolysis and/or gasification unit having a pyrolysis region may be used as a first ATT unit 50. In a preferred embodiment, the first ATT unit 50 is a rotable cylindrical retort.

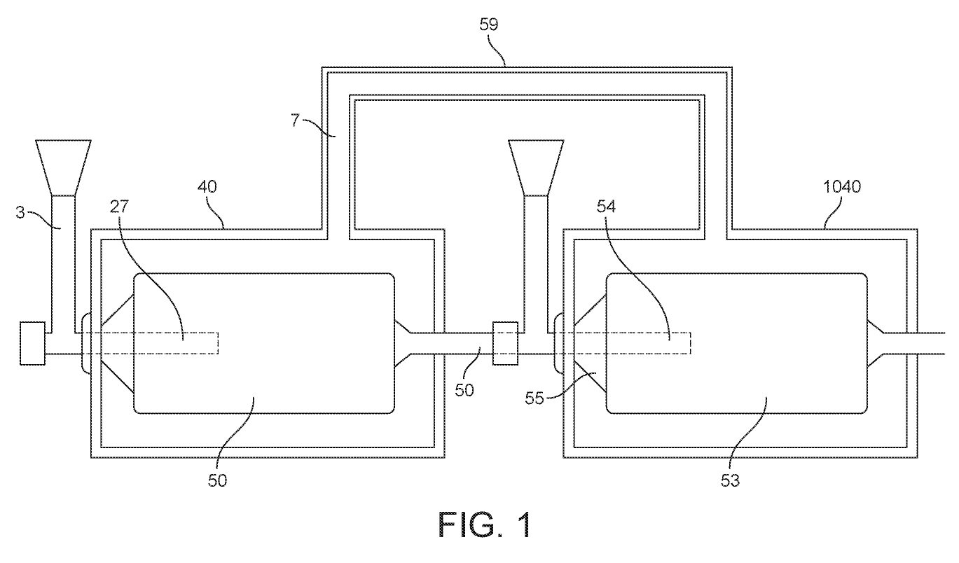

Referring to FIG. 1, feedstock enters the first ATT unit 50 at a first end via a feedstock input pipe 3. Preferably, the feedstock input pipe 3 includes an airlock 2 to regulate the amount air entering the first ATT unit 50. In some aspects, the feedstock input pipe 3 includes a CO₂ feed supply 8 to introduce CO₂ (carbon dioxide) between the airlock 2 and the retort. The CO₂ in the feedstock input pipe 3 may be at a greater pressure than atmosphere, thereby minimising the amount of air entering the first ATT unit 50. As discussed in “An Investigation into the Syngas Production From Municipal Solid Waste (MSW) Gasification Under Various Pressure and CO₂ Concentration” (Kwon et al, presented at the 17^{th} Annual North American Waste-to-Energy Conference 18-20 May 2009, Chantilly, Va., US, Proc 17th Annual North American Waste-to-Energy Conference NAWTEC17, paper NAWTEC17-2351), CO₂ injection enables char reduction and produces a significantly higher proportion of CO. Additionally, CO₂ injection reduces the levels of Polycyclic Aromatic Hydrocarbons (PAHs), which can be directly related to tar and coke formation during an advanced thermal treatment (gasification or pyrolysis) process.

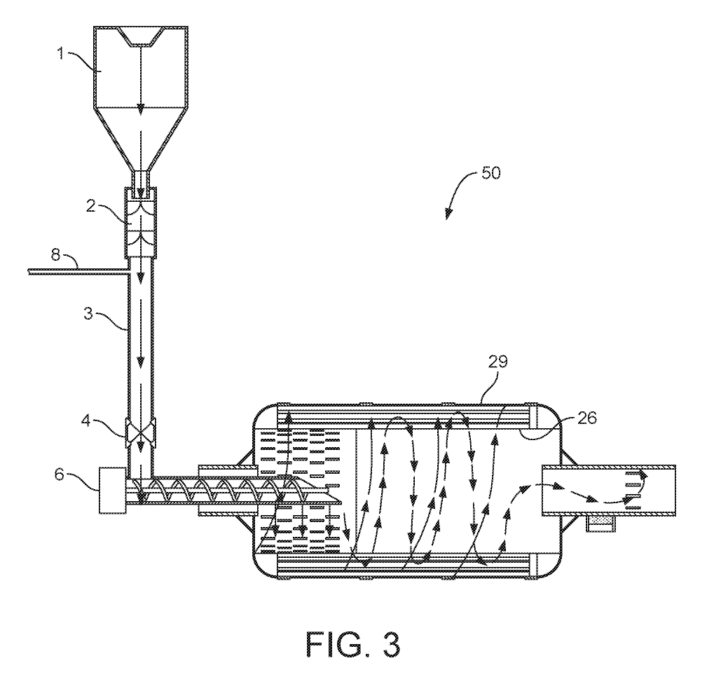

In the arrangement of FIG. 3, the first ATT unit 50 includes an inner retort 29. The inner retort 29 has holes in its surface to allow feedstock to pass from the inner retort 29 to an outer retort 26. The outer retort 26 has a larger cross-sectional diameter than the inner retort 29 thereby forming an annular cavity between the two. The inner retort 29 and the outer retort 26 are coaxial, with the inner retort 29 being located substantially within the outer retort 26 and both are substantially hollow and cylindrical in shape. The inner retort 29 may be rotated relative to the outer retort 26 by a drive motor 6. The inner retort 29 carries outward-facing vanes and the outer retort 26 carries inward-facing vanes, which act as in the above described prior art to increase the dwell time of the feedstock and char, and to mechanically break solid matter into smaller portions.

A retort exit opening is located at a second (discharge or exit) end, opposed to the first end, of the first ATT unit 50 to allow a gaseous mixture to exit the retort structure 50. The gaseous mixture contains syngas but, if the ATT process in the first ATT unit 50 is not efficient, can also contain comprising tars, oils and PAHs. Additionally, if the feedstock included a moisture content, the gas mixture will include water vapour. The retort exit opening is connected to inter unit piping 56 that connects to the input end of a second ATT unit 53, thereby forming a hermetically sealed gas path between the first and second ATT units. In some aspects, the inter unit piping may be connected to the first ATT unit 50 via another system of piping, or other device, such as a booster fan to impel the gaseous mixture along the inter unit piping 56 or a compressor to increase the pressure of the gaseous mixture before it is input into the inter unit piping 56.

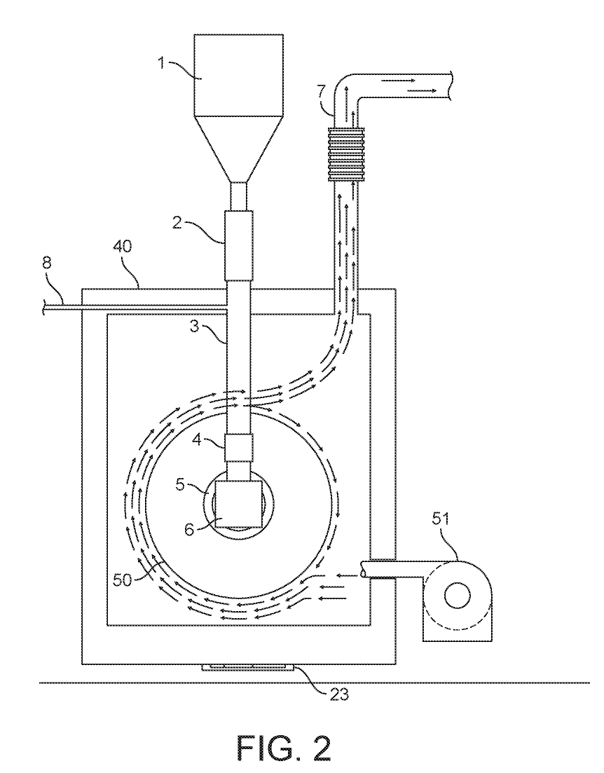

The interior of the first thermally insulated housing 40 is heated by a first heating system 52. That first heating system comprises at least one heat source 51. As shown in FIG. 2, the heat source 51 directs heated air into the interior of the thermally insulated housing 40, but the interior of the retort 50 is isolated from the remaining interior of the thermally insulated housing 40.

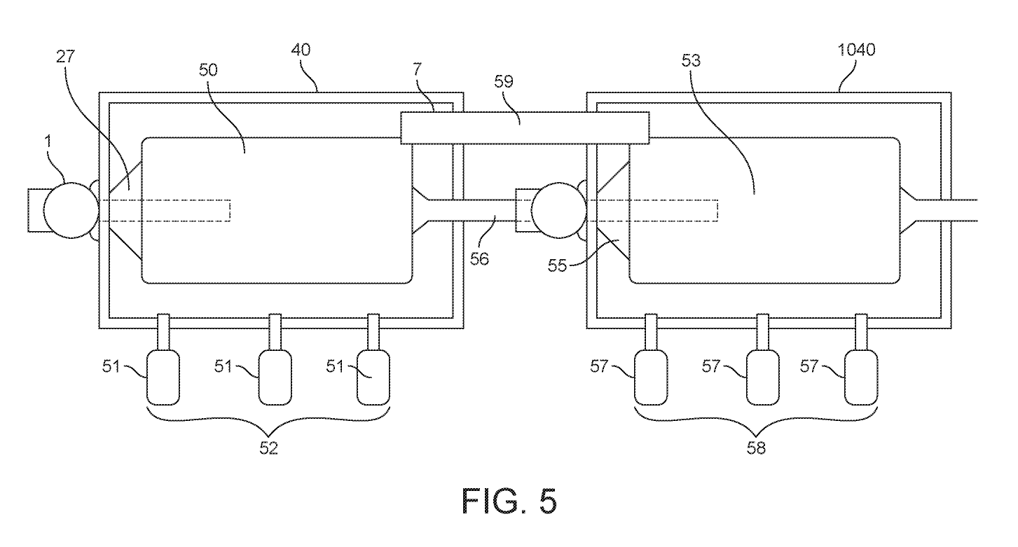

In the preferred embodiment, as shown in FIG. 5, the first heating system 52 comprises three heat sources 51 external to a first thermally insulated housing 40, and spaced along the length of the first ATT unit 50. In some aspects, the heating sources 51 comprise burners. The heating sources 51 may be at different temperatures. In the preferred embodiment, the heat source 51 nearest the feedstock input hopper 1 is the hottest. As the feedstock is the coldest on entry into the retort 50, the retort 50 will be coldest near the feedstock input hopper 1. Accordingly, it is advantageous to locate the hottest heat source 51 proximate the feedstock input hopper end of the retort 50 in order to minimise any potential temperature gradient along the length of the retort 50.

The first thermally insulated chamber 40 includes an exhaust pipe 7. As the heat source 51 provides more heated air to the interior of the first thermally insulated housing 40, exhaust is emitted. In the preferred embodiment, as shown in FIGS. 1 and 5, the exhaust is directed from the exhaust pipe 7 of the first thermally insulated housing 40 to the interior of the second thermally insulated housing 1040 by an exhaust duct 59. Accordingly, air heated by the heat sources 51 of the first ATT unit 50 is used to heat the second ATT unit 53. The heat sources 57 of the second ATT apparatus do not, therefore, need to provide as much heat as the heat sources 51 of the first ATT apparatus. The heat sources 57 of the second ATT apparatus may, in some aspects, be ‘top-up’ heat sources.

### Second ATT Apparatus

The inter unit piping 56 is connected to an input pipe 54 to the second ATT unit 53. In the preferred embodiment, the second ATT unit 53 is a cylindrical retort. The second ATT unit 53 is similar to the first ATT unit 50, and corresponding elements are not repeated.

The gaseous mixture from the first ATT unit 50 passes through the hermetically sealed gas path (inter unit piping 56 and input pipe 54) and enters the second ATT unit 53 through a bearing 55 of the second ATT unit 53. In the arrangement shown in FIGS. 1 and 5, for example, an input tube 54, connected to the inter unit piping 56, extends into the second ATT unit 53. The gaseous mixture is therefore directed into the centre of the second ATT unit 53.

In the preferred embodiment, inter unit piping 56 is connected to the input tube 54, which may also be connected to a feedstock input pipe 103 of the second ATT unit 53, and contain an auger 1037. That input tube 54 may be a perforated tube. The input tube 54 therefore functions similarly to the substantially horizontal pipe 27 of the first ATT unit 50, albeit with input tube also housing gaseous mixture from the first ATT unit 50. Similarly to the first ATT unit 50, the feedstock input pipe 103 of the second ATT unit 53 may include an airlock 102, a CO₂ input pipe 108 and a feed hopper 101.

The feedstock for the second ATT unit 53 may be different from the feedstock for the first ATT unit 50. For example, whereas feedstock for the first ATT unit 50 may be largely untreated (other than to ensure it is physically the correct size to fit in the ATT unit 50), feedstock for the second ATT unit 53 may be pre-sorted or dried to improve the quality of syngas exiting the second ATT unit 53. In other aspects, the same feedstock can be used in both the first ATT unit 50 and the second ATT unit 53.

Conventionally, a heated retort is only heated from the outside. This creates a temperature gradient, where the greatest temperature is at the surface of the retort and the lowest temperature is toward the axis of the retort. This leads to a cooler area toward the axis of the retort, where the temperature may not be sufficient for an ATT process despite the average temperature of a retort being sufficiently high to pyrolyse or gasify feedstock. Advantageously, the gaseous mixture in the preferred embodiment acts as a heat source along the axis of the second ATT unit 53, thereby raising the lowest temperature of the temperature gradient. As a result, the average temperature inside the second ATT unit 53 is higher and there is an increased probability of gas at the centre of the retort 53 being broken down.

If the feedstock input into the first ATT unit 50 contained moisture, the gaseous mixture also includes superheated steam, or super critical water. Accordingly, the ATT process in the second ATT unit 53 takes place in the presence of superheated steam or super critical water, thereby increasing the production of high energy gases (such as methane), whilst reducing the amount of char. Additionally, organic matter, including volatile organic compounds (VOCs), can be converted into syngas.

It will be appreciated that, in other embodiments, the second ATT unit 53 is not a cylinder, but a heated gaseous mixture from a first ATT unit 50 may still enter the second ATT unit 53 raising the average temperature therein.

The second ATT unit 53 is constructed from a different material than the first ATT unit 50 in some aspects. For example, in some aspects, courser material is used as feedstock for the first ATT unit 50 that the second ATT unit 53. The material used to construct the first ATT unit 50 must therefore be more durable than the material used to construct the second ATT unit.

The second ATT unit 53 may be constructed of a material having higher coefficient of thermal conductivity than the material used to construct the first ATT unit 50. Less heat is therefore required to produce a pyrolysis process in the second ATT unit 53. When the exhaust from the first thermally insulated housing 40 is directed to the interior of the second thermally insulated housing 1040, as shown in FIG. 1, the heat sources 57 of the second ATT apparatus are used to ‘top-up’ the heating provided by the exhaust from the first thermally insulated housing 40 (i.e. the heat sources operate at a reduced capacity), thereby creating a more efficient ATT system as a whole. For example, in some aspects the first heating system 52 can provide air heated to between 1100° C. and 1600° C. The exhaust directed to the second ATT apparatus can be at temperature of 800° C. to 900° C. If the second ATT unit 53 has a higher coefficient of thermal conductivity, the temperature of the exhaust from the first ATT apparatus may be sufficient to heat second ATT unit 52 such that the interior of the second ATT unit is at a temperature sufficient for an ATT process (pyrolysis or gasification process). The second heating system 58 can be used to provide additional heat to supplement that provided by the exhaust.

In the arrangement shown in FIG. 5, the number of heat sources 51 in the first heating system 52 and the number of heat sources 57 in the second heating system 58 is shown as being the same for illustrative purposes. In some aspects, the second heating system 58 has fewer heat sources 57 than the first heating system 52.

The number of heating units in the first and second heating systems does not have to be the same. For example, the second heating system may contain more heating units if it is desirable that the second ATT unit 53 operates at a higher temperature than the first ATT unit 50.

### Second Preferred Embodiment

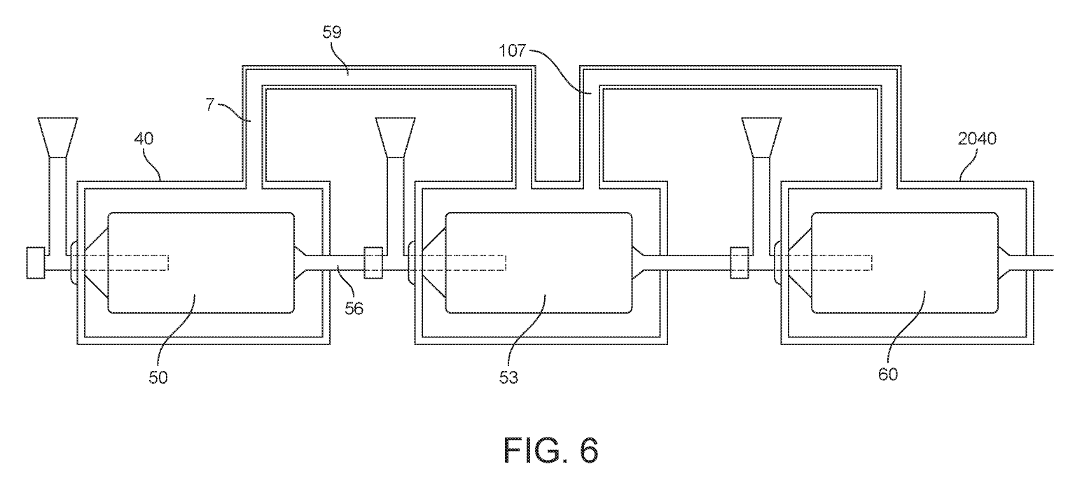

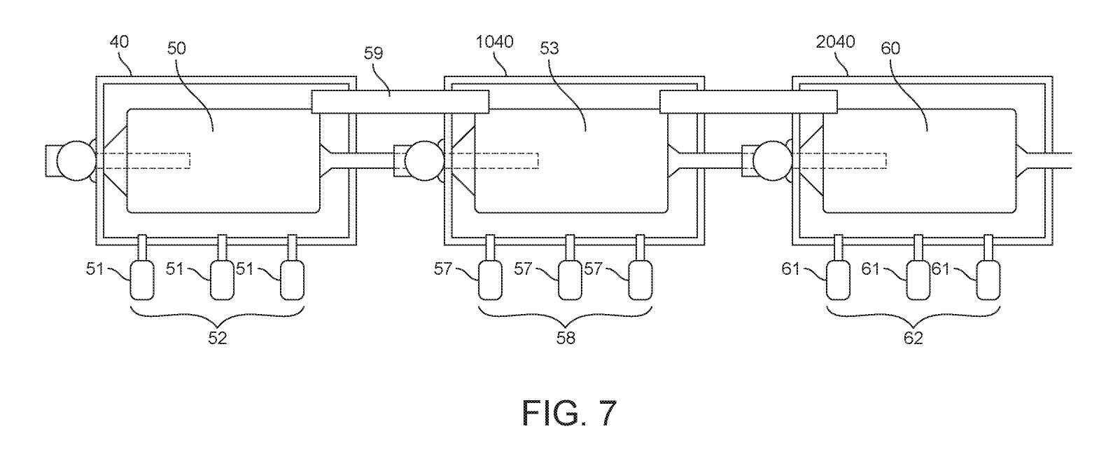

The first embodiment, two ATT units (pyrolysis or gasification units) were provided. In the second embodiment, more than two ATT units are provided. FIGS. 6 and 7 show an arrangement having a third ATT apparatus, including a third ATT unit 60, a third thermally insulated housing 2040, and a third heating system 63. The third heating system 63 is shown as having three heat sources 61, but one or more heat sources 61 may be provided.

The first and second ATT apparatuses of the second embodiment are the same as the first and second ATT apparatuses of the first embodiment. It will be noted, however, that an exhaust pipe 107 of the second ATT apparatus (not shown in FIGS. 1 and 5) is connected to a second exhaust duct 64 to direct exhaust from the second ATT apparatus to the interior of the third thermally insulated housing 2040. Second inter unit piping 66 connects the second ATT unit 53 to the input pipe 2054 to the third ATT unit 60. Accordingly, the hermetically sealed gas path extends from the first ATT unit 50 to the third ATT unit 60.

It will be appreciated that still further ATT units can be provided. For example, an arrangement with four ATT units is envisaged. Further exhaust ducts and inter unit piping is provided for the ATT apparatuses that include those still further ATT units. It will be appreciated that the hermetically sealed gas path will extend from the first ATT unit to the final ATT unit.

### Other Aspects, Embodiments and Modifications

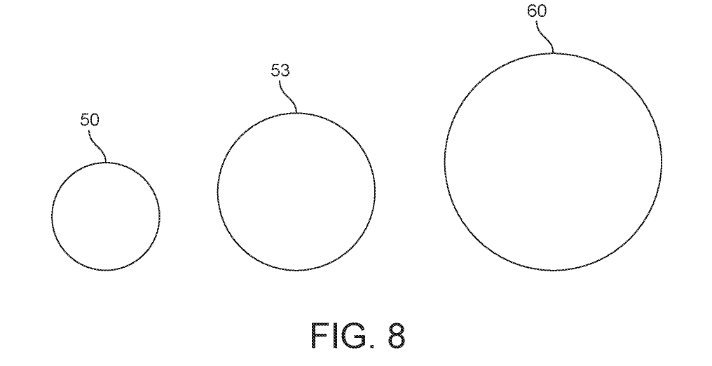

In some arrangements, the size of the ATT units may increase from the first ATT unit to the last ATT unit. FIG. 8 shows an arrangement in which the diameter of three consecutive cylindrical retorts increases from the first to the third retort. An initial pyrolysis process occurs in the first retort 50 which can create a gaseous mixture with a temperature of between 350° C. and 1000° C. (preferably in the range 900° C. to 1000° C.). That gaseous mixture is then provided to middle of the second retort 53. Accordingly, heat is transferred into the second retort 53 from two directions; firstly, the surface of the retort 53 is externally heated by the heating system 58 and the exhaust from the first ATT apparatus via the exhaust duct 59 and, secondly, from the gaseous mixture input from the first retort 50. The diameter of the second retort may therefore be increased in size without having a cooler region, in which the temperature is not sufficient for an ATT process, inside the second retort 53 that conventionally occurs from only externally heating a retort.

When a third retort 60 is provided, as shown in FIGS. 6 and 7, the diameter of the third retort 60 may be larger than the diameter of the second retort 53, as shown in FIG. 8. The gaseous mixture entering the third retort 60 has now been heated in the first and second retorts. The temperature of the gaseous mixture entering the third retort 60 will, on average, be higher than the temperature of the gaseous mixture entering the second retort 53. Accordingly, the temperature provided by the gaseous mixture near the axis of the third retort 60 is greater, meaning the diameter of the third retort 60, which is also externally heated by the third heating system 62, can be larger than the diameter of the second retort 53 without having the cooler region, in which the temperature is not sufficient for an ATT process, inside the third retort 60.

The hermetically sealed gas path may include a portion located proximate to the exterior surface, and extending along the length, of the first ATT unit 50. For example, when the first ATT unit 50 is a rotable retort, a system of piping 28 may extend from the second end of the first ATT unit 50, and along the length of the first ATT unit 50. In some aspects, the system of piping 28 may include several pipes extending along the length of the first ATT unit 50, or one pipe that extends along the length of the first ATT unit 50 several times. As the system of piping 28 has a smaller cross section than the first ATT unit 50, the average temperature within the system of piping 28 is higher than the average temperature in the first ATT unit 50. Accordingly, a further ATT process may occur within the system of piping 28 proximate to the exterior surface of the ATT unit. Additionally, if the hermetically sealed gas path extends along the length of the first ATT unit 50 several times, the dwell time of the gaseous mixture in the system of piping 28 is increased, thereby increasing the chances of hydrocarbons cracking, which results in a reduction of PAHs, tars and oils.

In an alternative aspect, the first and second ATT units may be located within the same thermally insulated housing 40, together with the hermetically sealed gas path, to reduce the number of heating units required to heat both the first and second ATT units.

If the first and second ATT units are located within a single thermally insulated housing 40, a single heating system 52 may be used to heat both ATT units.

One or both of the first and second ATT units is constructed at least in part of copper in some aspects. Details of a retort constructed at least in part of copper are provided in the co-pending application, filed the same day as the present application, having the title, “Pyrolysis Retort” and having the attorney reference J102646GB, the entirety of which is incorporated herein by reference.

In the preceding embodiments, a cylindrical rotating retort has been described. However, in other embodiments, different shapes could be adopted. For example, the cross-section does not need to be constant along the entire length of the retort—it could flare or narrow downwards.

Likewise, whilst a circular cross-section is convenient to manufacture, non-circular cross-sections could be used; an elliptical cross-section increases the dwell time on some parts of the retort which may be useful in some cases. Many other cross-sections could be used, though sharp corners might tend to trap material. The rotation employed might likewise be provided using elliptical gears or other means to vary the rotational speed within each rotation, so as to control the dwell time on different sectors of the retort.

Whilst rotation, unidirectional or bidirectional, has been described, it would be possible to turn the retort through less than an entire turn before reversing it—in other words, to apply a rotational oscillation. In this case, the retort does not need to be enclosed but could be a concave, for example semicircular, surface.

Other aspects which might be used with the present invention are described in our co-pending applications incorporated in their entirety by reference, filed the same day as the priority application for the present application, GB1503770.8, and with the following titles and application numbers:
GB1503766.6 “Pyrolysis Methods and Apparatus”
GB1503760.9 “Pyrolysis or Gasification Apparatus and Method”
GB1503765.8 “Pyrolysis Retort Methods and Apparatus”
GB1503772.4 “Temperature Profile in an Advanced Thermal Treatment Apparatus and Method”
GB1503769.0 “Advanced Thermal Treatment Methods and Apparatus”

A person skilled in the art would understand that various types of heat source and fuels therefor could be used, in addition to those described above and in the co-pending applications mentioned above.

Many other variants and embodiments will be apparent to the skilled reader, all of which are intended to fall within the scope of the invention whether or not covered by the claims as filed. Protection is sought for any and all novel subject matter and combinations thereof disclosed herein.

1. A system for pyrolysis or gasification having a first pyrolysis or gasification unit connected to a second pyrolysis or gasification unit by a hermetically sealed gas path.

2. A system of claim 1, wherein the second pyrolysis or gasification unit is a rotable retort.

3. A system of claim 2, wherein the hermetically sealed gas path connects to the second pyrolysis or gasification unit through a bearing of the retort.

4. A system of claim 1, wherein the first pyrolysis or gasification unit is a rotable retort.

5. A system of claim 1, wherein a perforated gas input pipe is located inside the second pyrolysis or gasification unit and the hermetically sealed gas path is connected to the perforated gas input pipe.

6. A system of claim 1 further comprising a first thermally insulated housing enclosing the first pyrolysis or gasification unit and a second thermally insulated housing enclosing the second pyrolysis or gasification unit.

7. A system of claim 6, wherein an exhaust duct connects the first thermally insulated housing to the second thermally insulated housing, the exhaust duct being adapted to direct exhaust from the interior of the first thermally insulated housing to the interior of the second thermally insulated housing.

8. A system of claim 7, further comprising a first heating system adapted to heat the interior of the first thermally insulated housing and a second heating system adapted to heat the interior of the second thermally insulated housing.

9. A system of claim 1, wherein the coefficient of thermal conductivity of the second pyrolysis or gasification unit is higher than the coefficient of thermal conductivity of the first pyrolysis or gasification unit.

10. A system of claim 1, comprising a thermally insulated housing enclosing the first pyrolysis or gasification unit, the second pyrolysis or gasification unit and the hermetically sealed gas path.

11. A method for pyrolysis or gasification, characterised in that gas resulting from a first pyrolysis or gasification process in a first pyrolysis or gasification unit undergoes a second pyrolysis or gasification process in a second pyrolysis or gasification unit.

12. A method of claim 11, wherein the gas is directed along a hermetically sealed path from the first pyrolysis or gasification unit to the second pyrolysis or gasification unit.

13. A method of claim 11, wherein the gas resulting from the first pyrolysis or gasification process includes a moisture content.

14. A method of claim 13, wherein the pressure and temperature in the second pyrolysis unit are sufficient that the moisture content is in a supercritical state.

15. A method of claim 13, wherein the pressure and temperature in the second pyrolysis unit are sufficient that the moisture content becomes superheated steam.

16. A method of claim 11, wherein wet feedstock having a moisture content of 20%-30% by weight is input into the first pyrolysis or gasification unit.

17. A method of claim 11, wherein exhaust from a first heating system associated with the first pyrolysis or gasification unit heats the second pyrolysis or gasification unit.

18. A method of claim 17, wherein a second heating system associated with the second pyrolysis or gasification unit heats the second pyrolysis or gasification unit
